(19) United States
(12) Patent Application Publication
(10) Pub. No.: US 2026/0319437 A1
(43) Pub. Date: Oct. 15, 2026

(54) HOROLOGICAL REGULATING ORGAN WITH BALANCE SPRING AND MEANS FOR COMPENSATING AGEING

(71) Applicant: The Swatch Group Research and Development Ltd, Marin (CH)

(72) Inventor: Mohammad Hussein KAHROBAIYAN, Boudevilliers (CH)

(73) Assignee: The Swatch Group Research and Development Ltd, Marin (CH)

(21) Appl. No.: 19/635,912

(22) Filed: Apr. 1, 2026

(30) Foreign Application Priority Data
Apr. 11, 2025 (EP) 25170105.8

(51) Int. Cl. G04B 17/20; G04B 17/04

(52) U.S. Cl. CPC G04B 17/20; G04B 17/045

(57) ABSTRACT

A regulating organ (1) for a horological movement including an oscillating mass, for example a balance, a balance spring including a flexible strip (2) wound around itself in several coils, the strip (2) having a predetermined stiffness to enable the oscillating mass to make a rotational oscillatory movement, the strip (2) including an outer end (9). The regulating organ (1) includes a resilient device for compensating rate drift, configured to adapt its stiffness to the ageing of the regulating organ, the resilient device including a resilient element (5) connecting the outer end (9) to a first support (7) that is immobile relative to the horological movement, as well as prestressing means (6) for applying a variable force or couple to the resilient element (5), the force or couple decreasing over time. Also, a horological movement including such a regulating organ (1).

### CROSS REFERENCE TO RELATED APPLICATIONS

This application claims priority to European Patent Application No. 25170105.8, filed on Apr. 11, 2025, the entire contents of which are incorporated herein by reference.

### TECHNICAL FIELD OF THE INVENTION

The invention relates to the field of horology, and more specifically to the field of mechanical horology, in which the motive energy is regulated by a regulating organ.

The invention relates more specifically to a regulating organ with means for compensating rate drift, particularly for horology, a horological movement comprising such a regulating organ, and a timepiece comprising such a horological movement.

### TECHNOLOGICAL BACKGROUND

In most mechanical watches, the energy required to rotate the hands (for example, the minute and hour hands) is accumulated in a barrel, then dispensed by a sprung balance system, which comprises a flywheel called a balance, combined with a spring in the form of a strip wound into a spiral, called a balance spring.

At an inner end, the balance spring is attached to an arbor that rotates with the balance; at an outer end, the balance spring is attached to a balance spring stud fitted on a stud holder, which is itself attached to a fixed bar (or cock).

The rotation of the balance is maintained- and its oscillations counted-by an escapement mechanism comprising a pallet driven by a low amplitude oscillating movement, provided with two pallets that engage the teeth of an escapement wheel. When thus engaged, the escapement wheel is forced into a step-by-step rotational movement at a velocity determined by the oscillation frequency of the pallet, which is itself set to the oscillation frequency of the sprung balance.

In a conventional escapement mechanism, the oscillation frequency is around 4 Hz, or approximately 28,800 vibrations/hour (A/h). Good horologists aim to ensure that the balance oscillates isochronously and steadily (meaning that the rate remains constant).

It is common practice to set the rate of the balance by adjusting the active length of the balance spring, defined as the curved length between its inner end and a measuring point located near the outer end of the balance spring and generally defined by a pair of stops carried by a key fitted on an index assembly.

When in operation, this index assembly is rotationally fixed relative to the axis of the balance spring. However, the angular position can be fine-tuned by hand, for example by pivoting it using a screwdriver or an eccentric mechanism that acts like a cam on the index assembly.

The assembly comprising the bar, the index assembly, the key, the balance spring stud holder, the balance spring stud, the arbor, the spring and the balance is commonly referred to as the “regulating organ.” Examples of regulating organs are provided in European patent EP 2 876 504, which was granted to horologist manufacturer ETA.

There are index assemblies comprising a balance spring stud holder to which one end of the spring is fastened, and in which the index assembly key leaves some slack to allow the balance spring to move between the two stops. However, chronometric properties, particularly anisochronism with respect to amplitude, are very sensitive to slack in the balance spring at the index assembly key, and this slack is difficult to control with precision.

In some devices, the stops can be adjusted to tighten the balance spring to eliminate slack, particularly while the balance spring is in operation. In this case, the rate is first adjusted by moving the index assembly key, then the balance spring is tightened with the key. However, tightening the balance spring with the index assembly key could stress the balance spring and lead to chronometric errors, particularly due to off-centring of the coils. In addition, eliminating the slack also changes the rate, and once the balance spring has been tightened, the index assembly key can no longer be moved along the balance spring to fine-tune the rate.

Other balance springs comprise a built-in setting device. In these balance springs, the rate is not adjusted by changing the effective length of the balance spring, but by applying a force or a couple to a flexible element arranged in series with the balance spring. This makes it possible to change the stiffness of the flexible element and consequently of the balance spring as a whole, namely the strip and the flexible element. Adjusting the stiffness of the balance spring adjusts the rate of the regulating organ. Such a balance spring with a flexible element is described, for example, in patent applications EP4009115 and CH0700385/2021.

However, when in operation, such a regulating organ is exposed to disruptions due to the ageing of the parts in the regulating organ, resulting in variations in the frequency of the regulating organ. Frequency variation changes the rate of the regulating organ. This is referred to as the rate drift of the regulating organ.

### SUMMARY OF THE INVENTION

The present invention aims to remedy all or part of the drawbacks mentioned above by providing a horological regulating organ with a balance spring fitted with means for compensating the rate drift of the regulating organ.

To this end, the invention relates to a rotary regulating organ for a horological movement comprising an oscillating mass, for example a balance, a balance spring comprising a flexible strip wound around itself in several coils, the strip having a predetermined stiffness to enable the oscillating mass to make a rotational oscillatory movement, the strip comprising an outer end.

The invention is characterised in that the regulating organ comprises a resilient device for compensating rate drift configured to adapt its stiffness to the ageing of the regulating organ, in order to reduce rate drift, the resilient device comprising a resilient element connecting the outer end to a first support which is immobile relative to the horological movement, as well as prestressing means for applying a variable force or couple to the resilient element, the force or couple decreasing over time.

Such a resilient device compensates component ageing and wear, which slow the rate of the regulating organ. Indeed, decreasing the force or couple applied to the resilient element increases its stiffness, which in turn increases the rate of the regulating organ.

With the invention, ageing is compensated so that the rate remains substantially constant, or at least a significant decrease in the rate is avoided.

According to a particular embodiment of the invention, the prestressing means comprise a spring part connected to the resilient element, the spring part transmitting the force or couple to the resilient element.

According to a particular embodiment of the invention, the prestressing means comprise a distortable body that is at least partially in contact with the spring part during distortion.

According to a particular embodiment of the invention, the distortable body comprises a material that relaxes stress with ageing.

According to a particular embodiment of the invention, the stress-relaxing material comprises a metal, such as magnesium, copper, zinc or nickel, or a thermoplastic polymer, such as polyolefins, preferably polypropylene or polyethylene.

According to a particular embodiment of the invention, the spring part comprises a first flexible blade connected to the resilient element.

According to a particular embodiment of the invention, the spring part comprises a translation table connected to the first flexible blade, the distortable body being in contact with the translation table.

According to a particular embodiment of the invention, the regulating organ extends substantially in the same plane.

According to a particular embodiment of the invention, the resilient element comprises a suspended point mass and a pair of uncrossed blades connecting the suspended point mass to the first immobile support.

According to a particular embodiment of the invention, the prestressing means are connected to the suspended point mass to exert the force or couple on the suspended point mass.

The invention also relates to a horological movement comprising such a regulating organ.

### BRIEF DESCRIPTION OF THE FIGURES

The purposes, advantages and characteristics of the present invention will become apparent on reading several embodiments provided solely by way of non-limiting examples, with reference to the appended drawings in which:

FIG. 1 schematically shows a top view of a regulating organ according to a first embodiment of the invention in a first configuration, and

FIG. 2 schematically shows a top view of the regulating organ in FIG. 1 in a second configuration,

FIG. 3 is a graph showing the stress undergone by the material over time, and

FIG. 4 is a graph showing the force exerted on the resilient element by the prestressing means over time.

### DETAILED DESCRIPTION OF THE INVENTION

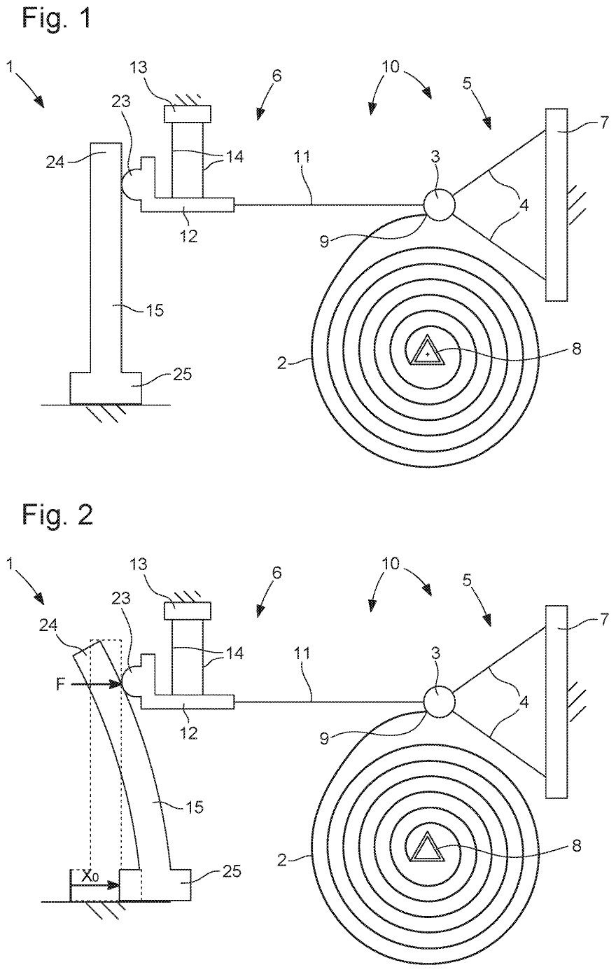

FIGS. 1 and 2 show an embodiment of a regulating organ according to the invention.

The regulating organ 1 comprises a balance spring with a flexible strip 2 wound on itself in several coils. The flexible strip 2 comprises an outer end 9 and an inner end 8.

The regulating organ 1 comprises an oscillating mass, for example an annular balance, not shown in the figures, that is connected to the inner end 8 of the strip 2, the strip 2 having a predetermined stiffness to enable the oscillating mass to make a rotational oscillatory movement. For example, the oscillating mass comprises an axial rotation arbor, the inner end 8 of the strip 2 being connected to said arbor.

Preferably, the regulating organ 1 extends substantially in the same plane, except for the oscillating mass, which oscillates in a parallel plane above the balance spring.

According to the invention, the regulating organ 1 comprises a resilient device 10 for compensating rate drift with ageing to adapt the rate so as to decrease the rate drift.

The resilient device 10 comprises a resilient element 5 connecting the outer end 9 to a support 7, which is immobile relative to the horological movement, for example a plate. The resilient device 10 further comprises prestressing means 6 for applying a variable force or couple to the resilient element 5 according to the desired rate setting.

In this example, the resilient element 5 comprises a suspended point mass 3 and a pair of uncrossed blades 4 connecting the suspended point mass 3 to the immobile support 7. The suspended point mass 3 is, for example, a cylindrical body with a height substantially equal to its diameter, the uncrossed blades 4 spreading from the suspended point mass 3 to the immobile support 7.

The resilient element 5 is arranged as an extension of the flexible strip 2, with the balance spring and the resilient element 5 adjacent to each other, but avoiding contact when the oscillating mass is oscillating.

The prestressing means 6 are designed to exert a force or couple on the suspended point mass 3.

The prestressing means 6 comprise a spring part with a flexible blade 11 connected to the suspended point mass 3. The flexible blade 11 preferably extends along the axis of symmetry of the resilient element, for example tangentially to the strip 2 on the balance spring, and is slightly offset from the outer end 9.

In this embodiment, the spring part of the prestressing means 6 comprises a translation table with a first L-shaped mobile element 12 and a second support 13 designed to be immobile relative to the movement. The first mobile element 12 is connected to the flexible blade 11 by one end of a first arm of the L. The second arm of the L comprises a rounded protrusion 23 on the outer side. The translation table comprises two substantially parallel flexible blades 14 connecting the first mobile element 12 to the second immobile support 13.

The prestressing means 6 further comprise a distortable body 15, the distortable body 15 exerting the variable force or couple depending on ageing on the mobile element 12 of the spring part.

In this example, the distortable body 15 has an elongate shape, and is arranged substantially perpendicular to the axis of the flexible blade 11 of the spring part, so that a free part 24 is in contact with the protrusion 23 on the second arm of the L. The distortable body 15 has a secured end 25 opposite the free end 24.

In FIG. 1, the free end 24 of the distortable body 15 is in contact with the protrusion 23 and exerts minimal force on the first mobile element 12, as it is in a slightly distorted configuration. Thus, in this configuration, the resilient element 5 undergoes a small change in stiffness, such that the rate of the regulating organ is only marginally changed.

In the configuration in FIG. 2, the secured end 25 is fixedly held under the translation table with an offset x, relative to its position in FIG. 1, such that the distortable body 15 has a curvature. The distortable body 15 thus exerts a greater force F on the protrusion 23 of the translation table.

The free part 24 pushes the first mobile element 12, such that the first flexible blade 11 transmits a force or a couple to the suspended point mass 3. This decreases the stiffness of the pair of uncrossed blades 4. Conversely, if the distortable body 15 straightens, the force exerted on the suspended point mass 3 is decreased, such that the stiffness of the pair of uncrossed blades 4 increases.

According to the invention, the distortable body 15 comprises, at least in part, a stress-relaxing material. Preferably, the distortable body 15 is entirely made of this stress-relaxing material.

Such a stress-relaxing material has a Young's modulus that decreases over time. In other words, when it is exposed to constant deformation, the stress and force it exerts decrease over time. So when it is exposed to a force exerting a distorting stress, its distortion increases over time for an identical force value and orientation.

There are different types of material with this property, for example metals such as magnesium, copper or zinc, or even nickel. Strain-relaxing polymers can also be used, such as thermoplastics, for example polyolefins such as polyethylene or polypropylene.

The time-related dependence of stress in materials can be described by an exponential decay function:

$$σ ( t ) = {σ}_{0} {e}^{- \frac{t}{λ}}$$

wherein λ is called the relaxation time constant. This constant depends on the material and is different for each material. A material with a suitable relaxation time constant can be chosen to compensate rate drift.

In this case, the force F exerted by the distortable body 15 on the translation table decreases over time, such that the stiffness of the resilient element 5 increases. This also increases the rate of the regulating organ. This increase makes it possible to compensate for the rate loss in the remaining components of the regulating organ, which is also caused by the ageing of these components.

As it ages, the first free part 24 of the distortable body 15 exerts less force on the protrusion 23, and therefore on the first mobile element 12, which moves while being guided by the first translation table. As a result, the resilient element 5 gradually receives less force from the first flexible blade 11. Its stiffness increases with ageing, as does the rate of the regulating organ 1, which compensates for the rate loss due to the ageing of the components.

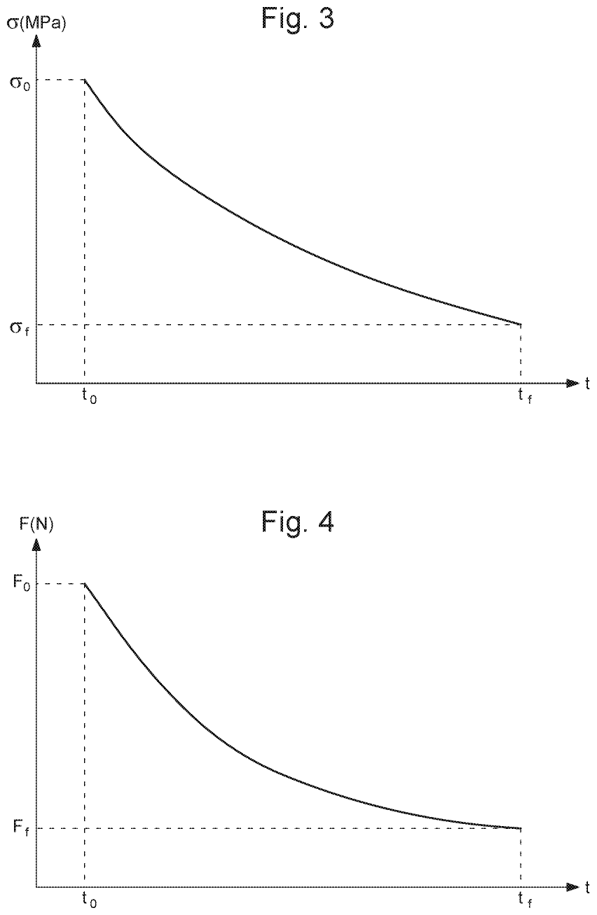

FIG. 3 shows a graph representing the stress σ(t) in the material, in particular σ₀ and σ_{f}, between the initial setting t₀ of the rate and after a relaxation time t_{f}, after the material has aged for a certain time. It can be seen that the stress decreases over time.

FIG. 4 shows the force F exerted by the distortable body 15 on the translation table between the initial rate setting t₀ and after the relaxation time t_{f}. The initial force F₀ is greater than the force F_{f} after the relaxation period. The resilient element 5 is thus less compressed, such that the rate of the regulating organ increases. This rate increase compensates for the ageing of the regulating organ that decreases the rate.

The invention also relates to a horological movement, not shown in the figures, the movement comprising a rotary regulating organ 1 as described above.

Naturally, the invention is not limited to the embodiments described with reference to the figures and alternative embodiments could be considered without departing from the scope of the invention.

1. A regulating organ (1) for a horological movement comprising:
an oscillating mass;
a balance spring comprising a flexible strip (2) wound around itself in several coils, the strip (2) having a predetermined stiffness to enable the oscillating mass to make a rotational oscillatory movement, the strip (2) comprising an outer end (9); and
a resilient device for compensating rate drift (50), configured to adapt its stiffness to the aging of the regulating organ, the resilient device comprising a resilient element (5) connecting the outer end (9) to a first support (7) that is immobile relative to the horological movement, as well as prestressing means (6) for applying a variable force or couple to the resilient element (5), the force or couple decreasing over time.

2. The regulating organ according to claim 1, wherein the prestressing means (6) comprise a spring part connected to the resilient element (5), the spring part transmitting the force or couple to the resilient element (5).

3. The regulating organ according to claim 1, wherein the prestressing means (6) comprise a distortable body (15) that is at least partially in contact with the spring part during distortion.

4. The regulating organ according to claim 3, wherein the distortable body (15) comprises a material that relaxes stress with ageing.

5. The regulating organ according to claim 3, wherein the stress-relaxing material comprises a metal, including magnesium, copper, zinc or nickel, or a thermoplastic polymer.

6. The regulating organ according to claim 1, wherein the spring part comprises a first flexible blade (11) connected to the resilient element (5).

7. The regulating organ according to claim 6, wherein the spring part comprises a translation table connected to the first flexible blade (11), the distortable body being in contact with the translation table.

8. The regulating organ according to claim 1, wherein the regulating organ (1) extends substantially in the same plane.

9. The regulating organ according to claim 1, wherein the resilient element (5) comprises a suspended point mass (3) and a pair of uncrossed blades (4) connecting the suspended point mass (3) to the first immobile support (7).

10. The regulating organ according to claim 9, wherein the prestressing means (6) are connected to the suspended point mass (3) to exert the force or couple on the suspended point mass (3).

11. A horological movement comprising a regulating organ (1) according to claim 1.
